(19) United States
(12) Patent Application Publication
(10) Pub. No.: US 2010/0019561 A1
(43) Pub. Date: Jan. 28, 2010

(54) HOIST EMPLOYING A MULTIPLE PISTON CYLINDER

(75) Inventor: R. Clay Dunigan, Benson, NC (US)

Correspondence Address: WITHROW & TERRANOVA, P.L.L.C., 100 REGENCY FOREST DRIVE, SUITE 160, CARY, NC, 27518, US

(73) Assignee: Gladiator Equipment LLC, Fayetteville, NC (US)

(21) Appl. No.: 12/179,339

(22) Filed: Jul. 24, 2008

(51) Int. Cl. B60P 1/16; B60P 1/04

(52) U.S. Cl. 298/22 P; 298/22 D

(57) ABSTRACT

A hoist is provided, which includes a hoist frame, a torque arm coupled to the hoist frame, and a lift arm coupled to the torque arm. The hoist also has a cylinder operatively coupled with the torque arm. The cylinder includes a cylinder shaft with multiple pistons disposed on the cylinder shaft. The multiple pistons define multiple piston chambers within the cylinder where, during operation of the hoist, the multiple pistons simultaneously operate to effect operation of the hoist.

### FIELD OF THE INVENTION

The present invention relates to hoists and more particularly to hoists employing at least one multiple piston cylinder.

### BACKGROUND OF THE INVENTION

Vehicles having a dump body typically employ a hoist. The hoist imparts a force on the dump body to tilt the dump body from a resting position to a dumping position. The ability of the hoist to impart a rotational force on a dump body dictates how much weight the dump body may hold. The greater the rotational force imparted by the hoist, the greater amount of weight the dump body may hold.

For example, FIG. 1 illustrates a typical hoist 10 employing a cylinder 12 coupled with a torque arm 14, and a lift arm 16 coupled with the torque arm 14. The lift arm 16 couples with a dump body 18 such that when the lift arm 16 moves, the dump body 18 also moves. During operation, the cylinder 12 moves in a direction defined by a directional arrow X, thereby imparting a linear force along direction X on the torque arm 14. The linear force causes the torque arm 14 to rotate, thereby creating a moment M₁ about an endpoint 20 of the torque arm 14. The rotation of the torque arm 14 causes the lift arm 16 to generally move in an upward direction Y. As the torque arm 14 rotates, the lift arm 16 moves the dump body 18 from a first position (not shown) to a second position.

The hoist 10 creates two forces while moving the dump body 18: a linear force along the direction X and the moment M₁. If it is desired to increase the rotational force imparted by the hoist 10 such as to increase the dump body 18 capacity, the linear force may be increased or the moment M₁ may be increased independent of the linear force. The cylinder 12 imparts the linear force through hydraulic pressure. In particular, pressurized fluid is fed into a piston 22 of the cylinder 12, which causes movement of a shaft 24. The pressurized fluid imparts the linear force along the shaft 24, which is translated to the torque arm 14. Thus, if the pressure of the pressurized fluid increases, the linear force imparted by the pressurized fluid also increases. However, in some applications, there are pressure rating limits for the piston 22. For example, pressurized fluid may not be fed into the piston 22 at more than 3000 psi in a hydraulic application. Otherwise, various components of the piston, such as seals, or the like, may prematurely wear, thereby causing failure of the hoist 10.

Furthermore, the overall dimensions of the cylinder 12 and the piston 22 may be increased by increasing a diameter of both the cylinder 12 and the piston 22 such that more pressurized fluid may be fed into the cylinder 12. However, when the diameters of the cylinder 12 and the piston 22 are increased, an overall size of the cylinder 12 also increases. Thus, the cylinder 12 may interfere with components of vehicle implementing the hoist, such as exhaust components, drivetrain components, powertrain components, and the like.

The moment M₁ acting about the endpoint 20 of the torque arm 14, may be increased independent of increasing of the linear force to increase rotational force. In order to increase the moment M₁ independent of the linear force, a length L₁ of the torque arm 14 may be increased. Nonetheless, increasing the length L₁ of the torque arm 14 increases the overall dimensions of the hoist 10. Thus, the hoist 10, which typically resides within a chassis of a vehicle having the dump body 18, may interfere with other components of the vehicle, such as the exhaust system, the differential, the suspension, or the like, of the vehicle.

Accordingly, what is needed is a hoist that can impart greater rotational forces to a dump body. Moreover, the hoist should have compact dimensions, such that the hoist does not interfere with other components of a vehicle using the hoist.

### SUMMARY OF THE DETAILED DESCRIPTION

Embodiments of the present invention provide a hoist employing at least one multiple piston cylinder to increase linear force. The hoist can be employed in a vehicle to tilt a dump body disposed on the vehicle such that media held by the dump body discharges when the dump body tilts. The hoist includes at least one cylinder having multiple pistons disposed on a single cylinder shaft, which increase the linear force imparted by the cylinder. In this manner, for example, a greater linear force may be achieved that may be possible given piston pressure rating limits for a particular application and/or moment limitations. For example, this may allow the hoist to reside substantially above a chassis of the vehicle such that the hoist does not interfere with components residing within the vehicle chassis, such as exhaust components, suspension hangers, fuel tanks, power train components, and the like, while still imparting a greater linear force. In further embodiments, the hoist may include two or more cylinders having multiple pistons, such that the hoist may tilt the dump body having heavier loads.

The multiple pistons allow for the use of a pressurized fluid having a pressure which does not cause the premature failure of components due to excessively high pressures, such as pressures exceeding 3000 psi. Furthermore, by using a cylinder having multiple pistons disposed on the same cylinder shaft, the overall dimensions of the cylinder are similar to a cylinder having a single piston.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates the operation of a hoist in accordance with the prior art;

FIG. 2 illustrates a vehicle, which uses a hoist of the present invention;

FIG. 3A is an embodiment of the present invention illustrating the hoist shown with respect to FIG. 2;

FIG. 3B shows the hoist shown with reference to FIG. 2 in a resting position in accordance with an embodiment of the present invention;

FIG. 3C illustrates an orientation of the hoist shown with respect to FIG. 2 relative to a chassis of the vehicle also shown with respect to FIG. 2 in accordance with an embodiment of the present invention;

FIG. 4 shows a detailed view of a cylinder of the hoist shown with reference to FIG. 2, in accordance with an embodiment of the present invention;

FIG. 5A is an embodiment of the present invention showing another view of the cylinder illustrated with reference to FIG. 4;

FIG. 5B shows the operation of the cylinder illustrated with reference to FIG. 4, in accordance with an embodiment of the present invention;

FIG. 6 is a side view of the hoist shown with respect to FIG. 2, in accordance with an embodiment of the present invention;

FIG. 7 illustrates a hoist having multiple cylinders, in accordance with a further embodiment of the present invention.

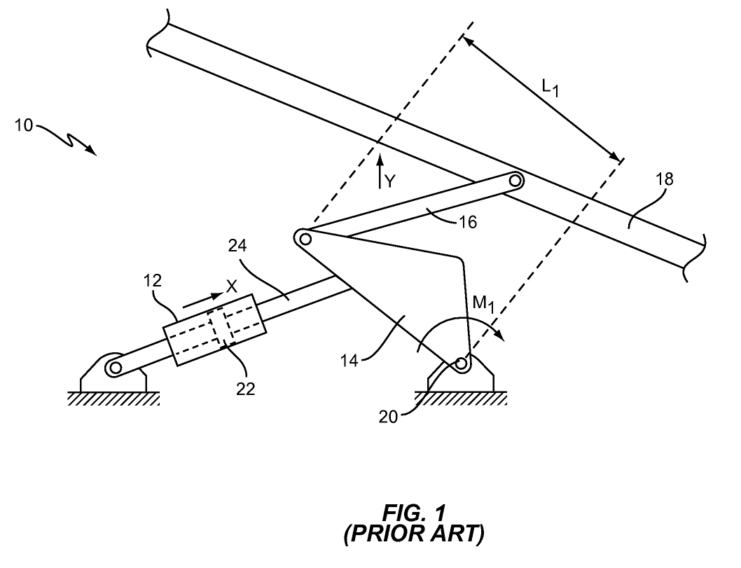

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Embodiments of the present invention provide a hoist employing at least one multiple piston cylinder to increase linear force. The hoist can be employed in a vehicle to tilt a dump body disposed on the vehicle such that media held by the dump body discharges when the dump body tilts. The hoist includes at least one cylinder having multiple pistons disposed on a single cylinder shaft, which increase the linear force imparted by the cylinder. In this manner, a greater linear force may be achieved that may be possible given piston pressure rating limits for a particular application and/or moment limitations. This may allow the hoist to reside substantially above a chassis of the vehicle such that the hoist does not interfere with components residing within the vehicle chassis, such as exhaust components, suspension hangers, fuel tanks, power train components, and the like, while still imparting a greater linear force. In further embodiments, the hoist may include two or more cylinders having multiple pistons, such that the hoist may tilt the dump body having heavier loads.

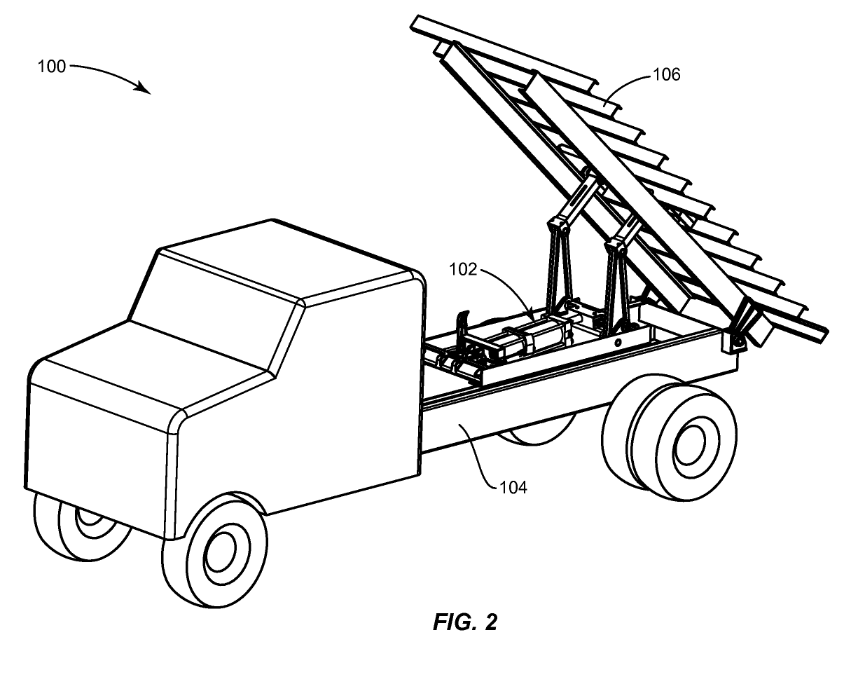

Prior to discussing the particular aspects of embodiments of the present invention, an environmental view of an exemplary application of a hoist employing multiple pistons is illustrated with reference to FIG. 2. FIG. 2 illustrates a vehicle 100 which employs a hoist 102. It should be noted that while the hoist 102 is shown with a vehicle 100, the hoist 102 is not limited to either vehicle or dump applications. The hoist 102 is disposed above a vehicle chassis 104 of the vehicle 100 and couples with a dump body 106 of the vehicle 100. The hoist 102 has imparted both a linear force and a moment which in turn caused the dump body 106 to tilt upward, such that the dump body 106 can discharge media (not shown) disposed thereon. In this example, the hoist 102 can tilt the dump body 106 at an angle between about 0 degrees and about 50 degrees in order to facilitate media discharge.

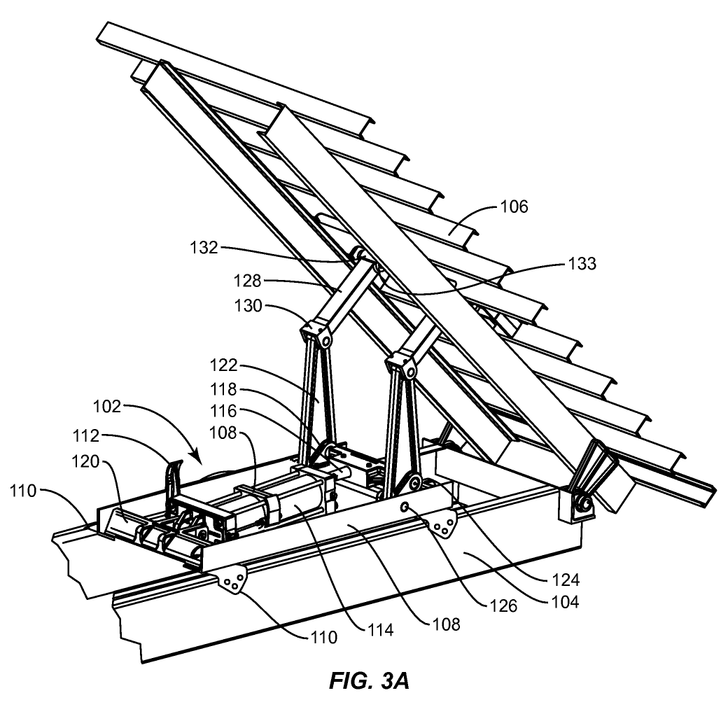

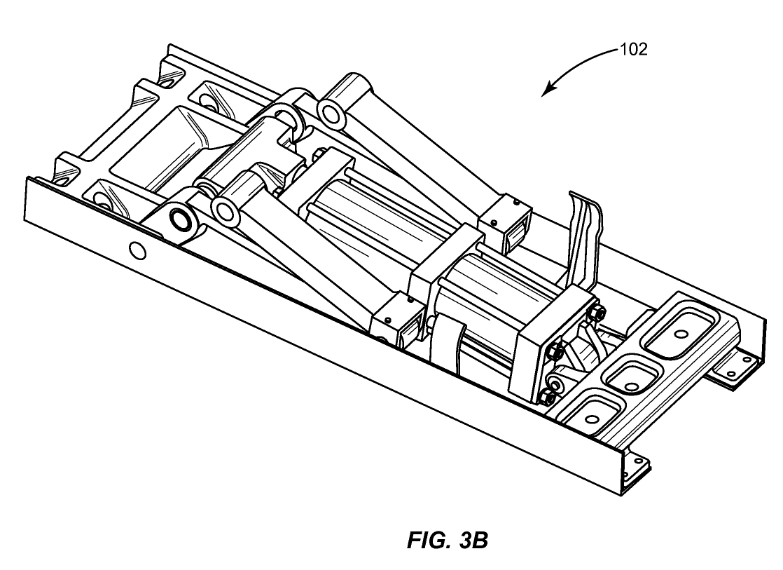

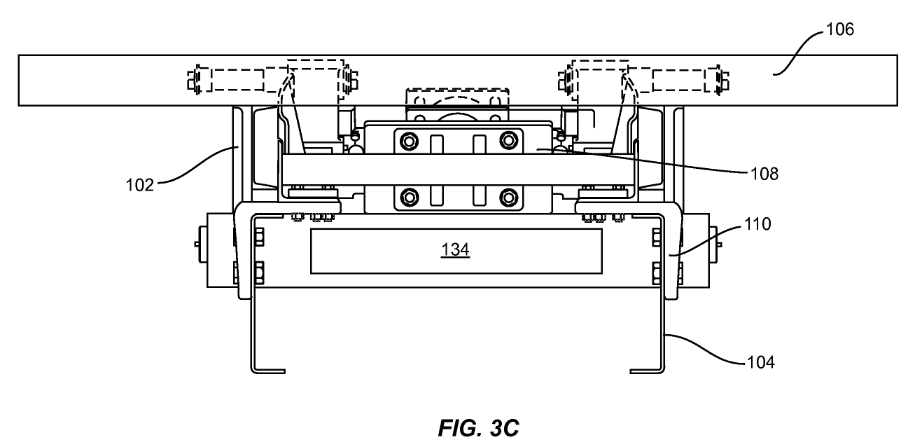

FIG. 3A illustrates the hoist 102 of FIG. 2 in greater detail. The hoist 102 includes a hoist frame 108, which couples the hoist 102 to the vehicle chassis 104. Hoist frame brackets 110 are employed to couple the hoist frame 108 to the vehicle chassis 104. In particular, the hoist frame brackets 110 couple the hoist frame 108 to the vehicle chassis 104 such that the hoist 102 is disposed above the vehicle chassis 104. The hoist 102 also includes a body guide 112, which guides the dump body 106 into position when the hoist 102 is in a resting position, as shown with reference to FIG. 3B. The hoist 102 is typically in a rest position when the dump body 106 is filled with media or when the vehicle 100 is in motion.

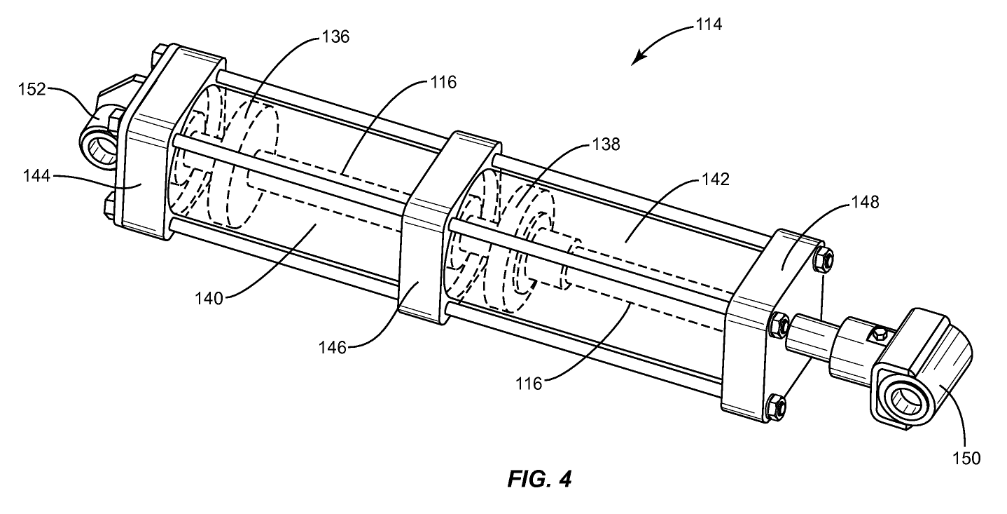

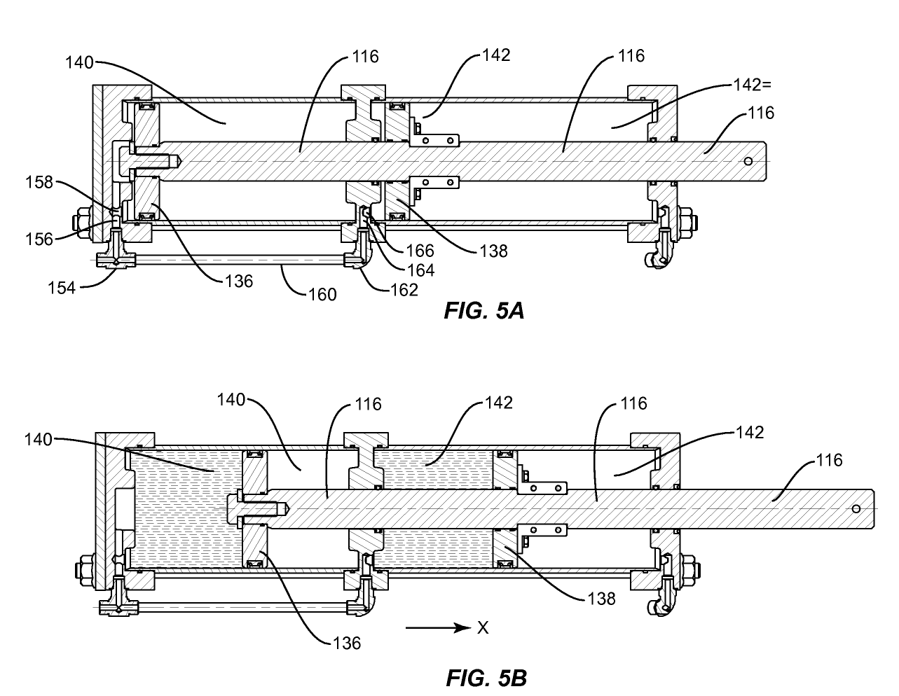

The hoist 102 illustrated in FIG. 3A also includes a cylinder 114 having a cylinder shaft 116 coupled to a cylinder yoke 118. As will be discussed in greater detail below with reference to FIGS. 4, 5A, and 5B, the cylinder 114 includes multiple pistons. Furthermore, the hoist 102 is shown as having a single cylinder 114 where the cylinder includes multiple pistons. However, the hoist 102 may employ multiple cylinders, where each cylinder of the multiple cylinders includes multiple pistons. The hoist 102 also includes a lower bunk 120 with which the cylinder 114 couples. The cylinder yoke 118 couples with a torque arm 122 via a cylinder yoke pivot 124. The cylinder yoke pivot 124 may be any coupling member which rotatably couples the cylinder yoke 118 with the torque arm 122, such as a wrist pin for example, or the like. The torque arm 122 couples with the hoist frame 108 at a torque arm pivot point 126. The torque arm pivot point 126 may include a wrist pin, or any other type of device, which facilitates rotational coupling.

The torque arm 122 also couples with a lift arm 128 via a pivot 130. The lift arm 128 couples with the dump body 106 via a lift arm pivot 132. The lift arm pivot 132 rotatably couples the lift arm 128 with the dump body 106, using a coupling member 133, such as a wrist pin for example, or the like. Thus, during rotation of the torque arm 122, the lift arm 128 also rotates, thereby moving the dump body 106.

As previously discussed, the hoist 102 substantially resides above the vehicle chassis 104 in the illustrated embodiment. FIG. 3C more clearly illustrates an orientation of the hoist 102 relative to the vehicle chassis 104 in accordance with this embodiment. Specifically, the hoist 102 resides above the vehicle chassis 104 such that the hoist 102 does not interfere with any components 134 residing between or below the vehicle chassis 104, where the hoist frame brackets 110 couple the hoist 102 with the vehicle chassis 104. Specifically, these components may include exhaust components, drivetrain components, powertrain components, suspension hanging points, a fuel tank, or the like.

As previously discussed, the hoist 102 includes the cylinder 114. Now making reference to FIG. 4, a more detailed view of the cylinder 114 is shown. The cylinder 114 provides an axial thrust to the hoist 102, such that the torque arm 122 (not shown) and the lift arm 128 (not shown) tilt the dump body 106 (not shown) from a resting position to a dumping position. The cylinder 114 includes multiple pistons, such as pistons 136 and 138, where the pistons 136 and 138 are disposed on the cylinder shaft 116 within the cylinder 114. The piston 136 defines a first cylinder chamber 140 and the piston 138 defines a second cylinder chamber 142. In this embodiment, the overall dimensions of the cylinder 114 are the same as if the cylinder 114 only included a single piston, such that the dimensions of the cylinder 114 are not altered in order to accommodate the pistons 136 and 138.

During operation of the cylinder 114, the pistons 136 and 138 move along an axial direction defined by the cylinder shaft 116, thereby effectuating tilting of the dump body 106. The cylinder 114 also includes a blind end cap 144, a center cap 146, and a rod end cap 148. The blind end cap 144 and the center cap 146, along with the piston 136, define the first cylinder chamber 140. The center cap 146 and the rod end cap 148, along with the piston 138, define the second cylinder chamber 142. The cylinder 114 also includes a cylinder shaft yoke 150 and a blind end pivot 152. The cylinder shaft yoke 150 rotatably couples the cylinder 114 to the cylinder yoke 118. When the pistons 136 and 138 move the cylinder shaft 116, the cylinder shaft yoke 150 causes rotation of the cylinder yoke 118. The blind end pivot 152 couples the cylinder 114 with the lower bunk 120.

Now making reference to FIG. 5A, an even further detailed view of the cylinder 114 is shown. The cylinder 114 includes a T-junction 154 in fluid communication with a runner 156 for the piston 136. The runner 156 is in fluid communication with a cylinder port 158. The cylinder 114 also includes a runner 160, which fluidly communicates the T-junction 154 with an L-junction 162. The L-junction 162 is in fluid communication with a runner 164 for the piston 138. The runner 164 is also in fluid communication with a port 166 for the piston 138.

During operation of the cylinder 114, a fluid, such as hydraulic fluid, air, or the like, feeds into the T-junction 154. The fluid then enters the runner 156 and the cylinder port 158. In addition, as fluid enters the T-junction 154, fluid also passes through the runner 160 and into the L-junction 162. Fluid entering into the L-junction 162 then passes through the runner 164 and into the port 166. Fluid from the cylinder port 158 and the port 166 then enters into the first and second cylinder chambers 140 and 142. As the fluid enters into the first and second cylinder chambers 140 and 142, the pistons 136 and 138 move along a direction X, thereby imparting a linear force along the direction X, as more clearly shown with reference to FIG. 5B. As the pistons 136 and 138 move along the direction X, the cylinder shaft 116 also moves, which in turn causes rotation of the cylinder yoke 118 along with the rotation of the torque arm 122.

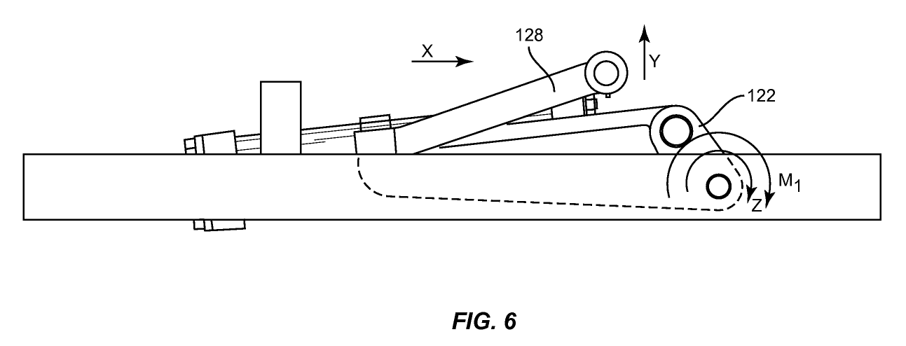

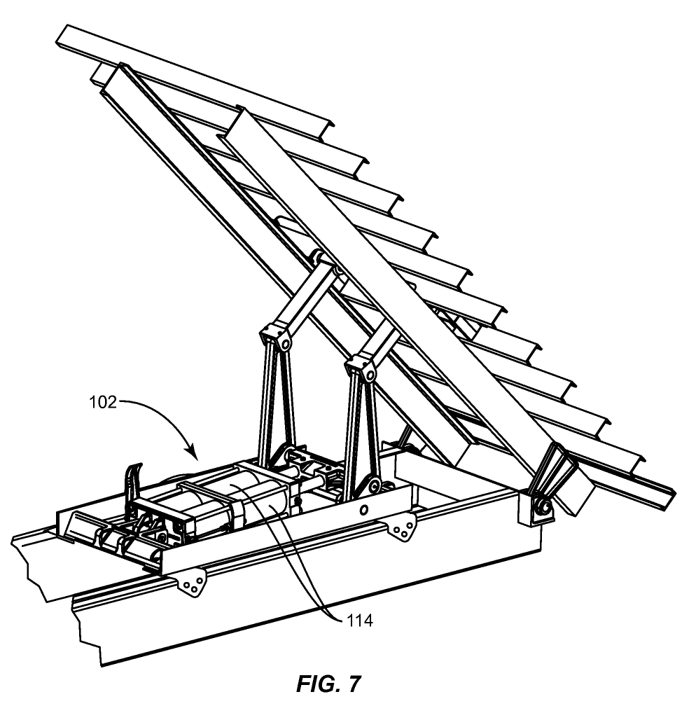

Now making reference to FIG. 6, as the cylinder yoke 118 rotates, the torque arm 122 also rotates along a direction Z, thereby creating a moment M₁. During rotation of the torque arm 122 along the direction Z, the lift arm 128 moves in an upward direction Y. As more fluid enters into the first and second cylinder chambers 140 and 142, the torque arm 122 continues to rotate in the direction Z and the lift arm 128 continues to move in the upward direction Y until the hoist 102 achieves the configuration shown with reference to FIG. 3A, wherein media disposed on the dump body 106 is discharged.

The use of multiple pistons, such as the pistons 136 and 138, in the cylinder 114 increases the overall linear force imparted by the cylinder 114. In particular, in embodiments where a pressurized fluid having a pressure of 3000 psi is used, the use of multiple pistons proportionally increases the linear force imparted by the cylinder 114 without increasing the dimensions of the cylinder. Thus, in embodiments where the cylinder 114 employs the two pistons 136 and 138, the two pistons 136 and 138 effectively double the force the cylinder 114 imparts. In embodiments where the cylinder 114 employs three pistons, the force imparted by the cylinder 114 effectively doubles. As the force imparted by the cylinder 114 increases, the moment acting about the torque arm 122 also increases. Thus, the length of the torque arm 122 does not need to be increased in order to increase the moment acting about the torque arm 122. Furthermore, since neither the dimensions of the cylinder 114 nor the length of the torque arm 122 increase, the dimensions of a hoist, such as the hoist 112, employing the cylinder 114, remain relatively compact.

In a further embodiment of the present invention, the hoist 102 may include multiple cylinders, where each of the multiple cylinders include multiple pistons, as shown with reference to FIG. 7. In particular, each cylinder has more than one piston as described with reference to FIGS. 4, 5A, and 5B. Furthermore, while the cylinders have been described as having two pistons, each cylinder may have more than two pistons. Thus, the hoist 102 may impart an even greater amount force during operation. For example, if the hoist includes two cylinder 114 each having pistons 136 and 138, the hoist 112 includes a total of four pistons such that the hoist 102 imparts a linear force which is four times greater than a hoist having a single cylinder that only has one piston. In addition, the hoist 102 in FIG. 7 imparts a force which is double the force of a hoist employing two cylinders having only one piston each.

Those skilled in the art will recognize improvements and modifications to the preferred embodiments of the present invention. For example, the hoist is not limited to vehicle or dumping applications. The hoist also includes multiple (meaning more than one) pistons. The hoist may include one cylinder or multiple cylinders. All such improvements and modifications are considered within the scope of the concepts disclosed herein and the claims that follow.

What is claimed is:

1. A vehicle hoist, comprising:
a hoist frame;
a torque arm coupled to the hoist frame;
a lift arm coupled to the torque arm; and
at least one cylinder operatively coupled with the torque arm, the at least one cylinder having a cylinder shaft with multiple pistons disposed on the cylinder shaft.

2. The vehicle hoist of claim 1, wherein the vehicle hoist couples with a vehicle and the vehicle hoist is disposed above a chassis of the vehicle.

3. The vehicle hoist of claim 1, further comprising:
a second cylinder, which includes:
a second cylinder shaft; and
multiple pistons disposed on the second cylinder shaft, wherein the torque arm operatively couples with the second cylinder.

4. The vehicle hoist of claim 1, further comprising a cylinder yoke operatively coupled with the at least one cylinder and the torque arm.

5. The vehicle hoist of claim 1, wherein the vehicle hoist is configured to couple with a chassis of a vehicle where a hoist frame bracket of the vehicle hoist couples the vehicle hoist to the vehicle chassis such that the vehicle hoist is disposed above the vehicle chassis.

6. A hoist comprising:
a hoist frame;
at least one cylinder having a single cylinder shaft coupled with the hoist frame, the at least one cylinder having multiple pistons disposed on the single cylinder shaft;
a torque arm operatively coupled to the at least one cylinder and the hoist frame; and
a lift arm operatively coupled to the torque arm.

7. The hoist of claim 6, further comprising:
a second cylinder, which includes:
a second cylinder shaft; and
multiple pistons disposed on the second cylinder shaft, wherein the torque arm operatively couples with the second cylinder.

8. The hoist of claim 6, further comprising a cylinder yoke operatively coupled with the at least one cylinder and the torque arm.

9. The hoist of claim 6, wherein the hoist is configured to couple with a chassis of a vehicle where a hoist frame bracket of the hoist couples the hoist to the vehicle chassis such that the hoist is disposed above the vehicle chassis.

10. A vehicle comprising:
a hoist coupled with the vehicle, the hoist comprising:
a hoist frame;
a torque arm coupled with the hoist frame;
a lift arm coupled with the torque arm; and
at least one cylinder operatively coupled with the torque arm, the at least one cylinder including:
a cylinder shaft; and
multiple pistons defining multiple cylinder chambers disposed on the cylinder shaft, wherein during operation of the hoist, the multiple pistons simultaneously operate to effect operation of the hoist.

11. The vehicle of claim 10, wherein when the hoist is coupled with the vehicle, the hoist is disposed above a chassis of the vehicle.

12. The vehicle of claim 11, further comprising:
a hoist bracket coupled with the hoist frame, wherein the hoist bracket couples with the vehicle chassis and is configured to hold the hoist above the vehicle chassis.

13. The vehicle hoist of claim 10, further comprising:
a second cylinder, which includes:
a second cylinder shaft; and
multiple pistons disposed on the second cylinder shaft, wherein the torque arm operatively couples with the second cylinder.

14. The vehicle of claim 10, further comprising:
a cylinder yoke operatively coupled with the at least one cylinder and the torque arm.
